(19) United States
(12) Patent Application Publication
(10) Pub. No.: US 2013/0159900 A1
(43) Pub. Date: Jun. 20, 2013

(54) METHOD, APPARATUS AND COMPUTER PROGRAM PRODUCT FOR GRAPHICALLY ENHANCING THE USER INTERFACE OF A DEVICE

(71) Applicant: Mrudul Vinod Pendharkar, Tampere (FI)

(72) Inventor: Mrudul Vinod Pendharkar, Tampere (FI)

(73) Assignee: NOKIA CORPORATION, Espoo (FI)

(21) Appl. No.: 13/331,856

(22) Filed: Dec. 20, 2011

(51) Int. Cl. G06F 3/048

(52) U.S. Cl. 715/765

(57) ABSTRACT

Provided herein is a method, apparatus and computer program product for of presenting a partial view of a representation of a full version of a program. In particular, the method may include providing for display of a plurality of tiles representing a plurality of programs, where a first tile of the plurality of tiles representing a first program includes a first partial view of a representation of a full version of the first program. The method may also include providing for display of an enlarged version of the first tile in response to a first input, where the enlarged version includes a second partial view of the representation of the full version of the first program which is larger than the first partial view.

### TECHNOLOGICAL FIELD

Example embodiments of the present invention relate generally to the presentation of information on a display, and more particularly, to a method for providing an increased level of information regarding available programs on the display of a device.

### BACKGROUND

The modern communications era has brought about a tremendous expansion of wireline and wireless networks. Computer networks, television networks, and telephone networks are experiencing an unprecedented technological expansion, fueled by consumer demand. Wireless and mobile networking technologies have addressed consumer demands while providing more flexibility and immediacy of information transfer.

Mobile devices, such as cellular telephones, have become smaller and lighter while also becoming more capable of performing tasks that far exceed a traditional voice call. Mobile devices are becoming small, portable computing devices that are capable of running a variety of applications, some of which benefit from a larger display. These devices are comparable in capabilities to laptop or desktop-type computers such that they can execute thousands of available applications. The portability of such devices may be enhanced by reducing their size, and hence, their display size. With limited display capability, only a select number of applications or icons representing applications or other information may be displayed at any given time. Therefore, optimization of the display area to enhance the user experience may be desirable.

### SUMMARY

In general, an example embodiment of the present invention provides an improved method of presenting a partial view of a representation of a full version of a program. In particular, the method of example embodiments may include providing for display of a plurality of tiles representing a plurality of programs, where a first tile of the plurality of tiles representing a first program includes a first partial view of a representation of a full version of the first program. The method may also include providing for display of an enlarged version of the first tile in response to a first input, where the enlarged version includes a second partial view of the representation of the full version of the first program which is larger than the first partial view. The first partial view of the representation of the full version of the program may depict a portion of the representation of the full version of the first program in the same scale as a full view of the representation of the full version of the first program. The second partial view of the representation of the full version of the first program may depict a portion of the representation of the full version of the first program in the same scale as the full view of the representation of the full version of the first program.

Methods according to example embodiments of the invention may include where one or more elements of the full view of the representation of the full version of the first program are accessible for viewing in the partial view and the second partial view of the representation of the full version of the first program via panning. The method may further include repositioning at least one of the plurality of tiles representing a plurality of programs in response to the first tile becoming an enlarged version of the first tile. The method may also include reducing the size of at least one of the plurality of tiles representing a plurality of programs in response to providing for display of an enlarged version of the first tile. The first program may include a home screen, a menu, or a collection of multiple programs.

Example embodiments of the invention may provide an apparatus including at least one processor and at least one memory including computer program code. The at least one memory and the computer program code configured to, with the at least one processor, cause the apparatus to provide for display of a plurality of tiles representing a plurality of programs, where a first tile of the plurality of tiles representing a first program includes a first partial view of a representation of a full version of the first program. The apparatus may be caused to provide for display of an enlarged version of the first tile in response to a first input where the enlarged version includes a second partial view of the representation of the full version of the first program which is larger than the first partial view. The first partial view of the representation of the full version of the first program may depict a portion of the representation of the full version of the first program in the same scale as the full view of the representation of the full version of the program. The second partial view of the representation of the full version of the first program may depict a portion of the representation of the full version of the first program in the same scale as the full view of the representation of the full version of the first program. One or more elements of the full view of the representation of the full version of the first program may be accessible for viewing in the first partial view and the second partial view of the representation of the full version of the first program via panning.

The apparatus may further be caused to reposition at least one of the plurality of tiles representing a plurality of programs in response to the first tile becoming an enlarged version of the first tile. The apparatus may be caused to reduce the size of at least one of the plurality of tiles representing a plurality of programs in response to providing for display of an enlarged version of the first tile. The first program may include a home screen, a menu, or a collection of multiple programs.

Embodiments of the present invention may provide a computer program product including at least one non-transitory, computer-readable storage medium having computer executable program code instructions stored therein. The computer executable program code instructions may include program code instructions for providing for display of a plurality of tiles representing a plurality of programs, where the first tile of the plurality of tiles representing a first program includes a first partial view of a representation of a full version of the first program, and program code instructions for providing for display of an enlarged version of the first tile in response to a first input, where the enlarged version comprises a second partial view of the representation of the full version of the first program which is larger than the first partial view. The first partial view of the representation of the full version of the first program may depict a portion of the representation of the full version of the first program in the same scale as the full view of the representation of the full version of the first program. The second partial view of the representation of the full version of the first program may depict a portion of the representation of the full version of the first program in the same scale as the full view of the representation of the full version of the first program. One or more elements of the full view of the representation of the full version of the first program may be accessible for viewing in the first partial view and the second partial view of the representation of the full version of the first program via panning.

A computer program product according to example embodiments of the present invention may further include program code instructions for repositioning at least one of the plurality of tiles representing a plurality of programs in response to the first tile becoming an enlarged version of the first tile. The computer program product may also include program code instructions for reducing the size of at least one of the plurality of tiles representing a plurality of other programs in response to providing for display of an enlarged version of the first tile.

Example embodiments of the invention may provide an apparatus including means for providing for display of a plurality of tiles representing a plurality of programs, where a first tile of the plurality of tiles representing a first program includes a first partial view of a representation of a full version of the first program. The apparatus may include means for providing for display of an enlarged version of the first tile in response to a first input where the enlarged version includes a second partial view of the representation of the full version of the first program which is larger than the first partial view. The first partial view of the representation of the full version of the first program may depict a portion of the representation of the full version of the first program in the same scale as the full view of the representation of the full version of the program. The second partial view of the representation of the full version of the first program may depict a portion of the representation of the full version of the first program in the same scale as the full view of the representation of the full version of the first program. One or more elements of the full view of the representation of the full version of the first program may be accessible for viewing in the first partial view and the second partial view of the representation of the full version of the first program via panning.

The apparatus may include means for repositioning at least one of the plurality of tiles representing a plurality of programs in response to the first tile becoming an enlarged version of the first tile. The apparatus may include means for reducing the size of at least one of the plurality of tiles representing a plurality of programs in response to providing for display of an enlarged version of the first tile. The first program may include a home screen, a menu, or a collection of multiple programs.

### DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an example embodiment of the present invention;

FIG. 2 is a schematic block diagram of an apparatus for providing a mechanism by which application and task manager display may be integrated according to an example embodiment of the present invention;

FIG. 3 is an illustration of a device displaying a program menu;

FIG. 4 is an illustration of a device displaying a full program;

FIG. 5 is an illustration of a device presenting an partial view of a representation of a full version of a program according to an example embodiment of the present invention;

FIG. 6 is an illustration of a device presenting an enlarged partial view of a representation of a full version of a program according to an example embodiment of the present invention;

FIG. 7 is an illustration of a device presenting an enlarged partial view of a representation of a full version of a program according to another example embodiment of the present invention;

FIG. 8 is an illustration of a device presenting an enlarged partial view of a representation of a full version of a program according to yet another example embodiment of the present invention;

FIG. 9 is an illustration of a device presenting two enlarged partial views of representations of full versions of two program according to an example embodiment of the present invention;

FIG. 10 is an illustration of a device presenting two enlarged partial views of representations of full versions of two program according to another example embodiment of the present invention;

FIG. 11 is an illustration of a device presenting a full view of a representation of a full version of a program according to an example embodiment of the present invention; and

FIG. 12 is a flowchart of a method for presenting a partial view of a representation of a full version of a program according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Devices that may benefit from example embodiments of the present invention may include portable devices, such as tablet computers, cellular telephones, portable media devices, or the like, which are enhanced by a graphical user interface presented on a display, such as a touch screen. As portability of these devices often relates to their size, a smaller size may enhance portability while potentially sacrificing the available display area. Therefore it may be desirable to optimize the display to present as much information as possible in an easily intelligible manner while providing multiple levels of interface with available programs.

Some embodiments of the present invention may relate to a provision of a mechanism by which the user interface is enhanced by presenting a menu to a user wherein the menu contains a plurality of tiles representing available programs including at least one tile which depicts a representation of a full version of a program. Available programs may include applications and functions of a device that are available to be executed or opened by a user or by the device itself while full programs include applications and functions which have been executed and are open or in process on a device. A representation of a full version of a program may include a snapshot of the full program or similar as will be further described below. The representation of a full version of a program need not require the program to be active or running. In some embodiments, the available programs may be depicted with a tile representative of the program (e.g., an icon) while other available programs may be depicted with a tile including a representation of the full version of the program that they represent. Additionally, in the case of a touch screen interface, the tiles representing available programs and the tiles including representations of the full versions of programs may be virtual keys such that they may be selected by a user to effect an action, such as opening an available program or expanding the view of the representation of the full version of the program. Tiles which include representations of full versions of the programs which they represent may be viewed simultaneously with tiles of other available programs. The representation of a full version of a program may display the status of the program or convey other information, for example, in the form of a snapshot of the full version of the program.

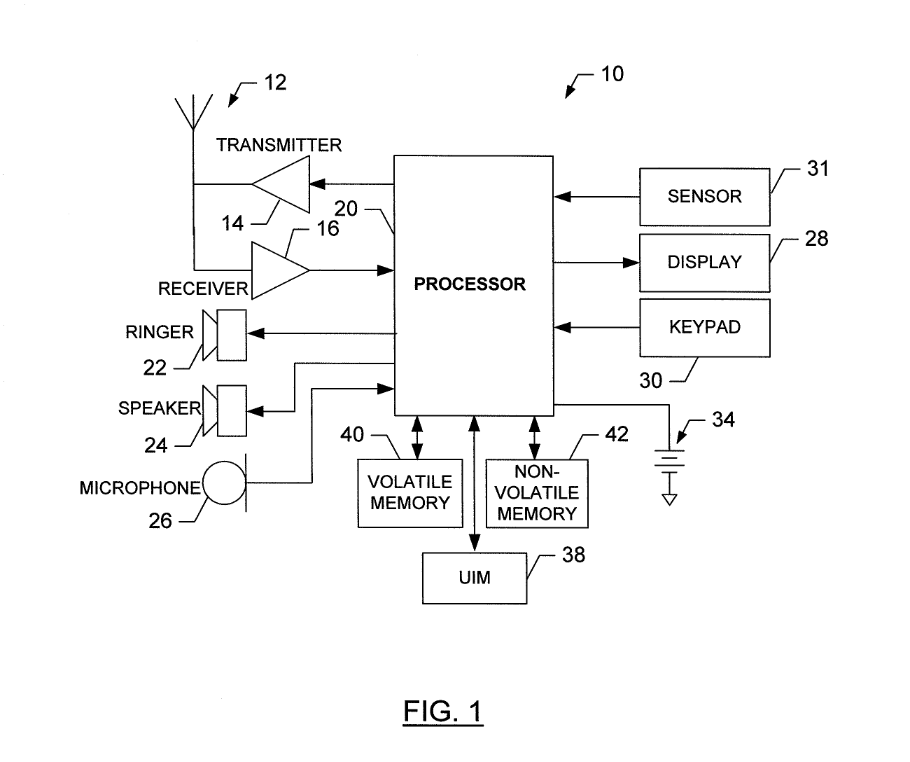

One example embodiment of the invention is depicted in FIG. 1 which illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

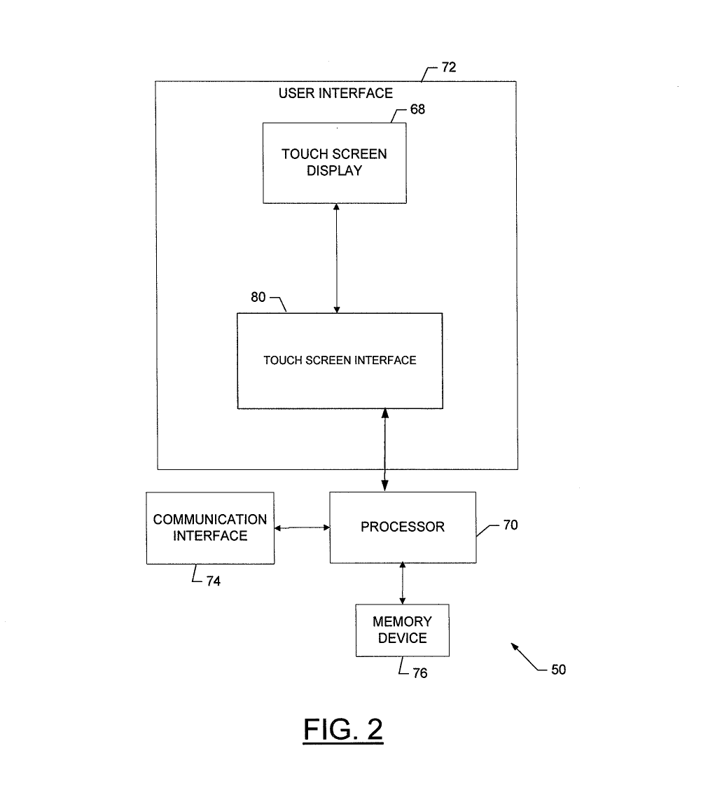

The mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch display (display 28 providing an example of such a touch display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch display may omit the keypad 30 and any or all of the speaker 24, ringer 22, and microphone 26 entirely. Additional input to the processor 20 may include a sensor 31. The sensor 31 may include one or more of a motion sensor, temperature sensor, light sensor, accelerometer, or the like. Forms of input that may be received by the sensor may include physical motion of the mobile terminal 10, whether or not the mobile terminal 10 is in a dark environment (e.g., a pocket) or in daylight, whether the mobile terminal is being held by a user or not (e.g., through temperature sensing of a hand). The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

As noted above, mobile terminals, including devices such as portable digital assistants (PDAs) and cellular telephones, are becoming smaller in size to allow for greater portability to the user. With the decrease in size of such devices, however, comes a decrease in the space available for displaying information. In other words, the size of the viewing area through which interactive content (e.g., contacts, e-mail messages, games, etc.) is presented to the user has become more limited as a result of more compact devices.

An example embodiment of the present invention will now be described with reference to FIG. 2, in which certain elements of an apparatus 50 for providing a mechanism by which relevant content may be determined and/or presented are illustrated. The apparatus 50 of FIG. 2 may be a device such as mobile terminal 10 of FIG. 1. However, it should be noted that the present invention may be embodied on any number of devices that include displays.

The apparatus 50 may, in some embodiments, be a mobile terminal (e.g., mobile terminal 10) as illustrated in FIG. 1 or a computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen(s), touch areas, device surfaces and/or sensors capable of detecting objects hovering over the surface, soft keys, a microphone, a speaker, motion sensor, temperature sensor, accelerometer, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the apparatus 50 may include or otherwise be in communication with a display, such as the illustrated touch screen display 68 (e.g., the display 28). In different example cases, the touch screen display 68 may be a two dimensional (2D) or three dimensional (3D) display. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, etc. techniques. The user interface 72 may be in communication with the touch screen display 68 to receive indications of user inputs at the touch screen display 68 and to modify a response to such indications based on corresponding user actions that may be inferred or otherwise determined responsive to the indications. In one alternative, a touch input may be provided other than by direct interaction with a display (e.g., in cases where the user interface is projected onto a wall with a projector, or where a cursor is used to direct input on the display).

In an example embodiment, the apparatus 50 may include a touch screen interface 80. The touch screen interface 80 may, in some instances, be a portion of the user interface 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an indication of an input in the form of a touch event at the touch screen display 68. As such, the touch screen interface 80 may be in communication with the touch screen display 68 to receive indications of user inputs at the touch screen display 68 and to modify a response to such indications based on corresponding user actions that may be inferred or otherwise determined responsive to the indications. Following recognition of a touch event, the touch screen interface 80 may be configured to determine a classification of the touch event and provide a corresponding function based on the touch event in some situations. Optionally, a device may be configured to recognize a hovering input where a user may use a stylus or finger to hover over a tile or interactive element and the device may be configured to recognize the hovering as an input, for example, by using user interface 72.

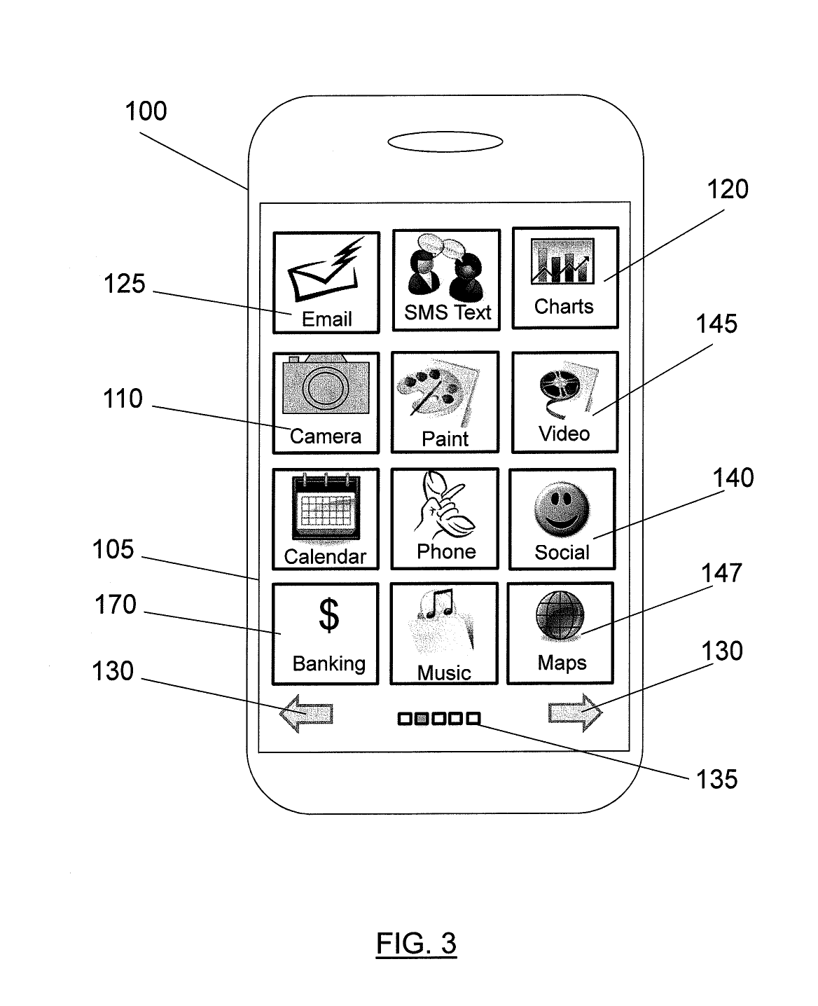

FIG. 3 illustrates a device 100 for providing a mechanism by which an increased level of information regarding available programs may be presented to a user. The term “program” as described herein can refer to any application or program of a device, such as a media player program, an email program, an interne browser, a device settings manager, a home screen which includes a program list or menu, or a media library, among many others. As such, the term “program” should not be limited to the embodiments described herein with regard to the example illustrations as any number of functions of a device may be considered a “program.”

FIG. 3 depicts a device, such as a mobile device (e.g., mobile terminal 10), that includes a display 105. The display may be of any known type including touch-screen displays; however, the touch-screen functionality is not necessary to implement example embodiments of the present invention. Depicted on the display 105 is a list of available programs presented as tiles (e.g., tiles 110, 120, 125, etc.) in an application list or menu. The depicted embodiment displays programs in a grid which may be a menu grid, home screen, or similar program showing a collection of multiple programs. While the depicted embodiment illustrates the tiles representing programs displayed in a grid, other embodiments may display the tiles in another arrangement conducive to displaying multiple tiles on the display. The tiles presented provide a user with visual representations of a plurality of available programs from which they may select.

The tiles may include illustrative figures or symbols indicating to a user a program associated with the tile. For example, a tile representing a camera program 110 may include a graphical representation of a camera, while a tile representing a spreadsheet program 120 may include a graphical representation of a spreadsheet or graph. Optionally, the tiles may further include names or nicknames adjacent to them indicating to which program each tile is associated. Such text names may be beneficial when multiple email or music player programs are available, or when the device includes a large number of programs. Names or nicknames may also be beneficial for programs for which there is no unique tile available, such as when a program developer has not created a unique icon for a program and/or when the operating system of the device uses a common program tile. Program tiles can optionally include an audio clip, video clip, or other multimedia data which may indicate to which program the tile is associated.

The display 105 of the device 100 may further include arrows 130 or other indications alerting a user that more programs may exist on the program list or menu, each of which may be accessible through a scrolling motion or by switching to another “page” on which programs may be listed. The arrows may be touch-sensitive virtual keys on a touch-screen (e.g., touch screen 68 of user interface 72) allowing a user to scroll through available programs by touching the arrows 130. The display 105 may further include a page indicator 135 to indicate to a user which page, of available pages that the user is viewing. In the illustrated example, the user is viewing the second page (the shaded box) of five available pages (represented by boxes), with an indication that one page is available to the left while three pages are available to the right. One of these pages, for example the one being viewed, may be considered a “home screen.” A home screen may be the default screen which is presented when the device is initially turned on or unlocked/awoken from a locked/sleep state. The home screen may be user selectable such that the screen can contain a user's preferred programs or other items of interest to a user. Optionally, programs may be contained within folders whereby a single folder on the top-level program menu or home screen may represent a number of program tiles. Program tiles accessed through a folder may be related by subject, frequency of use, or other means to group programs together.

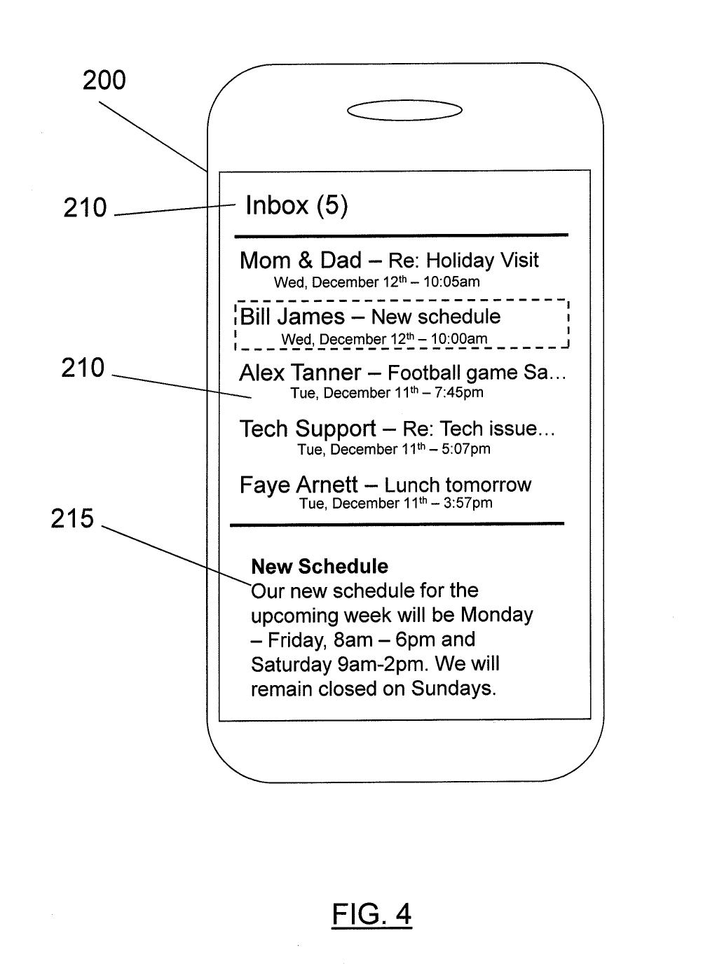

Generally, upon initiation or selection of a program (e.g., by selecting the tile representing the program through an input, such as the user interface 72), the program is opened (e.g., by the processor 70) and the full program comprising a full operational interface occupies substantially the entire display 105. FIG. 4 depicts an example embodiment of an email program which has been selected from the program menu. The term “full program” refers to a fully-functional operational interface of the program in which substantially all available functions and interactive elements are available to a user. Interactive elements may include menu functions, buttons, keys, virtual keys, and the ability to select objects, such as a song from a list or an email from a mailbox. The full program operational interface offers all available functionality of the program while also requiring the most processing capacity to allow these functions to be performed and to provide the most interactive graphical user interface (GUI).

The example embodiment of FIG. 4 includes a device 200, such as mobile terminal 10, with a display (e.g., touch screen display 68) depicting an email program including a header 210 which indicates the folder that the user is viewing, a list of recent emails received 210, and a preview pane 215 which displays the body of a selected email. In such an embodiment, the program generally occupies the entire display, or a significant portion thereof such that other programs are not generally visible or directly accessible. Additional interactive elements may be available through menus or presented upon selection of a displayed interactive element. For example, upon selection of a particular email from the email list 210 (e.g., through an input received at the user interface 72), the user may be presented with a plurality of discrete interactive elements such as interactive elements that provide for replying to an email, forwarding an email, filing an email, opening an attachment, cutting/pasting text, changing the folder viewed, deleting emails, sending to a printer, or otherwise interacting with the program at an interface level. The interface level being the level of interaction available with the program.

While the full program provides a fully-functional operational interface, the full program may also provide interactive elements that are seldom used or may not be required by a user for a brief interaction with the program. Further, the full program may consume processing capacity of the processor 70 and memory from memory device 76 that may slow the performance of a device (e.g., apparatus 50). Therefore, it may be desirable to provide a representation of a full version of the program which serves to convey relevant information to a user without launching or opening a full version of the program.

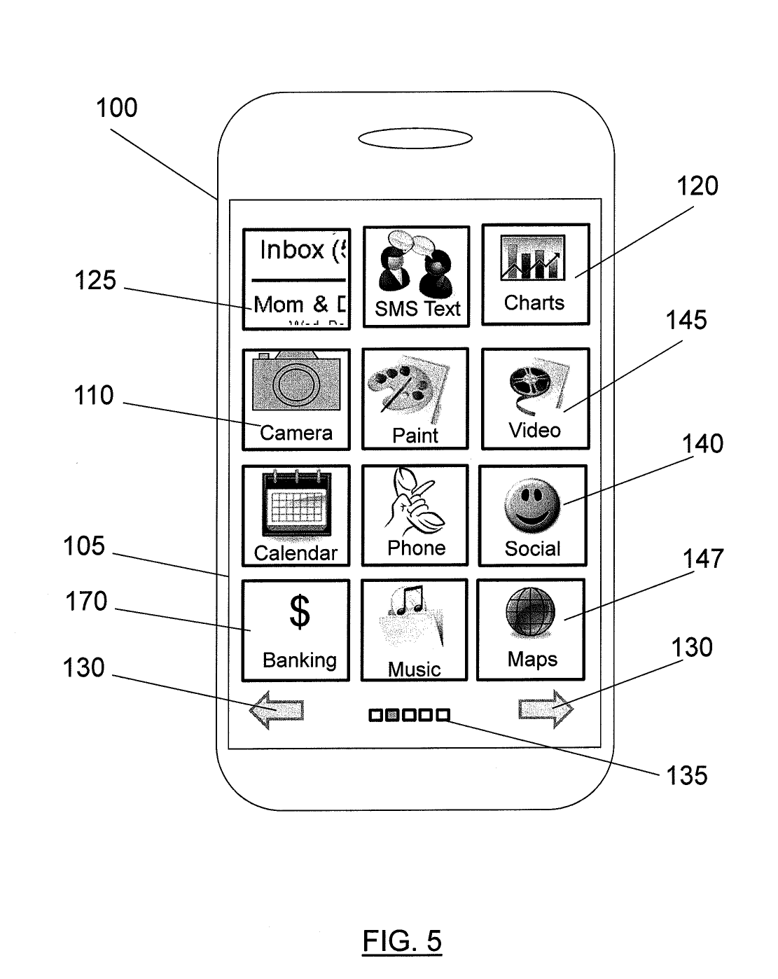

FIG. 5 illustrates an example embodiment of the present invention in which a plurality of tiles are displayed representing a plurality of programs including a first tile 125 representing a first program (e.g., an email program). The first tile 125 depicts a representation of a full version of the first program. FIG. 4 illustrates a full version of the email program represented by tile 125 of FIG. 3. In FIG. 5, the tile 125 representing the email program depicts a representation of a full version of the email program. The representation may include a snapshot of the current or a recent status of the program rather than a view of. A “snapshot” may include a screen-capture or other representation of the full version of the program. The snapshot may further include a depiction of how the program would appear if opened to the full version of the program. The snapshot may be updated periodically based on a timer (e.g., every five seconds) or on demand, such as when the screen presenting the tile 125 is displayed. The snapshot may be updated in real-time (e.g., constantly or whenever a change occurs that would affect how the program is displayed in its full version, such as when an email is received). The snapshot may not include the functionality of the full version of the program. Interactive elements available in the full version of the program may not all be available to a user viewing a representation of the full version of the program. Some interactive elements may be available to a user, such as options to start a full version of the program or to perform some functions (e.g., to read an email, to update the current weather) such as functions which don't require the processing capacity of the full version of the program.

Example embodiments that are configured to present a representation of the full version of a program may be facilitated by the software architecture framework. The representation of the full version of the program may be modified or determined by the software architecture framework. For example the developer of a program may not need to write additional program code to provide a version of the program that is configured to be viewed as a representation of the full version of the program, but rather the software architecture framework may interact with the program to provide the representation of the full version of the program. Therefore, custom software from the developer of the program may not be required to facilitate embodiments of the present invention.

In an example embodiment, the layout of tiles, the resizing of tiles, and the repositioning of tiles may be determined by the software architecture framework. The framework may provide a grid of rows and columns for the display area and the base size of a single tile may be defined by the framework based on the display area and/or a specified height and width. Each program may dictate how many rows and columns a tile representing that program should occupy on a grid, such as that of a program menu, application showing available programs, or home screen. Upon selection of a program by a user to enlarge the tile representing the program, the enlarged view framework may analyze the programs represented on the display and their respective sizes in order to determine which tiles or representations require repositioning and resizing. Programs may include a full version of the application depicted within the representation of the program or tile such that program developers do not need to create additional program language to develop smaller versions of the full version of the program.

While the snapshot depicted in the representation of the full version of the program may comprise an image of the full version of the application, the tile 125 may display a portion of the representation of the full version of the application in the same scale as the full version of the application. As shown in FIG. 5, the portion of the email program illustrated in the tile 125 is the same scale as the full version of the program shown in FIG. 4. While the full representation of the full version of the program may not be visible in the tile 125, a user may scroll or pan within the tile to view other areas of the representation of the full version of the program.

Further embodiments of the invention may include a representation of the full version of the program that is scaled or shown in a different level of detail (e.g., zoomed out) from the scale of the full version of the program. As illustrated in the example embodiment of the full version of the email program shown in FIG. 4, information that is more important may be depicted in a larger font than less important information (e.g., the name of the sender of an email may be more important than the time or date that it was received). Thus, in a scaled version of the representation of the full version of the program, the more important information may still be visible such that providing a scaled version of the representation may provide useful information while occupying a smaller portion of the display. This may allow a user to readily obtain information from the representation of a full version of the program without launching the program or expanding the representation to occupy a larger portion of the display. Optionally, the scaled version may alter the representation of a full version of a program by removing elements of the representation of the full version of the program deemed ancillary to the relevant information. For example, the software architecture framework which scales the representation may recognize elements of the representation (e.g., text, images, interactive elements, etc.) and determine whether the elements are to be depicted in the scaled version of the representation. The determination may include an analysis of whether the elements are static (e.g., elements that do not change), dynamic (e.g., elements which may change or be updated periodically), or elements that may become too small through scaling to be intelligible by a user. In such an analysis, some or all of the static elements may be omitted from a scaled version as the static elements may not provide useful, updated information. Elements that are determined to become illegible to a user through scaling may be omitted as they would not provide useful information to a user.

The determination regarding which elements may be included in a scaled version of the representation of a full version of the program may be performed by the software architecture framework rather than the program that is depicted in the representation, thereby not requiring the program developer to develop additional versions of the program to be shown in a scaled representation.

The partial view of a representation of a full version of the program may be initiated by a user providing an input (e.g., via user interface 72) to the tile which represents the program. While representation of a full version of the program may be desirable to a user who does not desire to use the interactive elements available in the interface level of the full program, the full program may be desirable to users who wish to use an interface level (and interactive elements) not available with the representation of a full version of the program. Therefore a user may be able to decide whether to open the representation of a full version of the program or a full program from the program menu depicted in FIG. 3. A user may initiate a representation of a full version of the program using a first input received, for example, at user interface 72, while a second input may initiate a full program. For example, in an embodiment implementing a touch-screen display (e.g., touch screen 68 of user interface 72), a single tap of a tile representing a program may initiate a representation of a full version of the program. A double-tap of the tile representing a program may initiate the full program, where a double-tap may be interpreted by two sequential taps of the display over the tile representing the program within a predetermined amount of time (e.g., one second or less).

Optionally, a first input may include a tap (e.g., momentary touch) while a second input includes a long press (e.g., a touch of a minimum duration, such as half of a second). Further, the inputs received may include a direction, such as a touch including a swipe to the upper right corner of a display (e.g., touch screen display 68) may be indicative of a first input, while a touch including a swipe to the lower left corner of the display may be indicative of a second input. Additional inputs may include combinations of available inputs including a tap, a double tap, a swipe, a brief press or touch, and a long press or touch among others. Any of these inputs, or combinations thereof may serve as the first input or the second input. Further, as noted above, a device may be configured to detect a hovering input. In such an embodiment, the proximity of the hovering element (e.g., a stylus or finger) to the user interface (e.g., user interface 72) may determine the input. For example, a hovering element hovering at a first distance (e.g., one centimeter) above an interactive element such as a tile may be interpreted as a first input while a hovering element hovering at a second distance (e.g., less than one centimeter) may be interpreted as a second input.

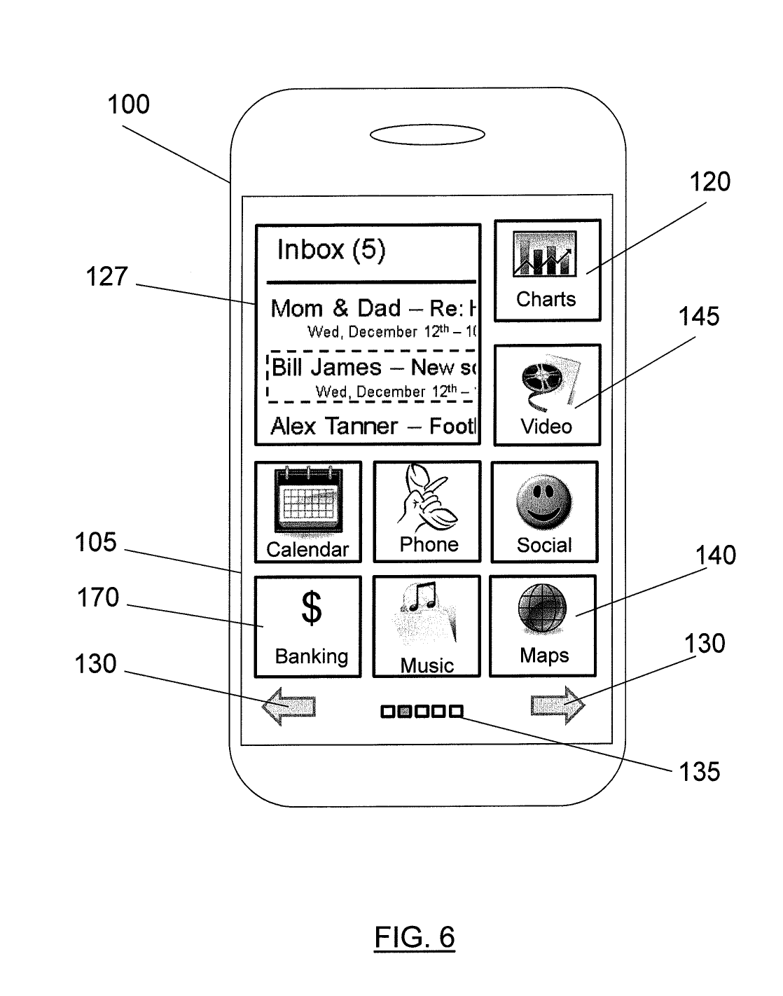

The representation of a full version of the program viewed as a tile in the program menu as illustrated in FIG. 5 or home screen and may provide a user with information regarding the program; however, it may be desirable for the user to view a larger version of the representation of a full version of the program. As such, when the representation of a full version of the program is displayed, a user may provide an input to enlarge the representation of a full version of the program. As described above, the input may be received via user interface 72 and may be any number of available touches, button presses, gestures, or the like. FIG. 6 illustrates an enlarged version 127 of the first tile 125 of FIG. 5 which may be presented in response to an input as received via the user interface 72, for example. The enlarged version 127 of the first tile 125 may resemble the partial view of the representation of a full version of the program; however, more of the representation can be seen with the larger size. Further, a user may still view the entire representation via scrolling or panning within the enlarged version 127 of the tile 125.

The enlarged version 127 of the tile 125 depicting a partial view of a representation of a full version of the first program of FIG. 6 is further depicted to occupy the space previously occupied by four tiles representing programs. The size of the enlarged version of the tile 127 may be of any size, but is generally smaller than the display 105 size in order to not monopolize the display 105. As illustrated, when the enlarged version of the tile 127 is displayed, tiles representing other programs (e.g., 120, 140) may still be displayed. In the illustrated embodiment of FIG. 6, the enlarged version of the tile 127 overlies previously displayed tiles shown in FIG. 3. The tiles representing the video program 145 and the map program 140 may still be accessed to initiate the full program or a tile representing a partial view of a representation of a full version of each respective program while the tiles representing programs that were substantially obscured by the intermediate operational interface 127 may not be readily available.

While the above embodiments have been described with respect to a “snapshot” of a program such as a screen-capture presented in the tile representing a program or an enlarged version of the tile representing the program, other embodiments may include a view of the running program. In such embodiments, more processing capacity may be used; however, the functionality of the running program would be readily available to a user wanting to interact with the program as viewed in the tile or the enlarged version of the tile.

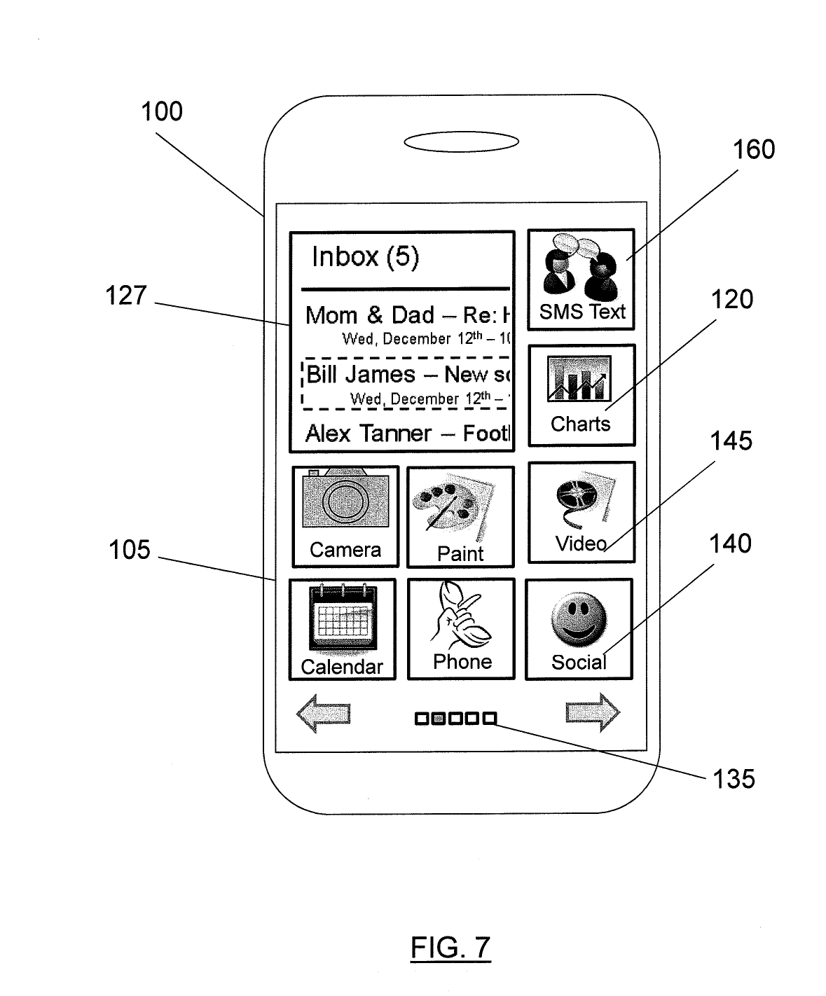

FIG. 7 illustrates the example embodiment of FIGS. 3 and 6; however, the tiles representing other programs (e.g. 160, 120) have been re-positioned on the display 105 in response to the email program opening to an enlarged version of the partial view of a representation of the full version of the email program 127. As illustrated and with reference to FIG. 3, the tile representing text messaging 160 has been moved such that the enlarged tile 127 does not obscure the tile 160 representing the text message application. Further, the tile representing the chart program 120 has also been repositioned as the tile representing the text messaging program 160 has displaced the chart program tile 120. Similarly, the tile representing the video program 145 and the tile representing the social networking program 140 have been moved down the display 105. The tiles representing the banking program 170 and the map program 147 have been dropped from the display 105 by virtue of the other tiles being repositioned.

The tiles that are repositioned may be repositioned according to a hierarchy or order that is determined by the user or by the device 100 itself (e.g., via processor 70). For example, a user may select their favorite programs and rank them from most important to least important. The most important programs may be represented by tiles closest to the top of the display while the least important programs are presented proximate the bottom of the display. In response to tiles being repositioned, the least important programs may be displaced from the display. Optionally, the device may determine (e.g., via processor 70) the most frequently used programs and maintain the most frequently used programs closest to the top of the display 105 and the last programs to be displaced.

Further example embodiments of the present invention may include hierarchies that are predictive or based upon device awareness. For example, a device according to embodiments of the present invention may include a calendar program in which a user may store scheduled meetings or appointments. A meeting or appointment scheduled within the calendar program may be scheduled as a video-conference with an agenda for the meeting attached to the appointment as a spreadsheet. The device may be configured with a first hierarchy which organizes program tiles in alphabetical order. At the time of the scheduled meeting, or a predefined amount of time before the scheduled meeting, the processor 70 of the device may be caused to switch to a second hierarchy in response to the anticipated meeting without user intervention, organizing the tiles representing programs according to those that are anticipated for use during the scheduled meeting. In the instant example, the hierarchy may present a video-conference program tile first, a spreadsheet program tile second, and subsequently list the remaining program tiles by the first hierarchy (e.g., alphabetically).

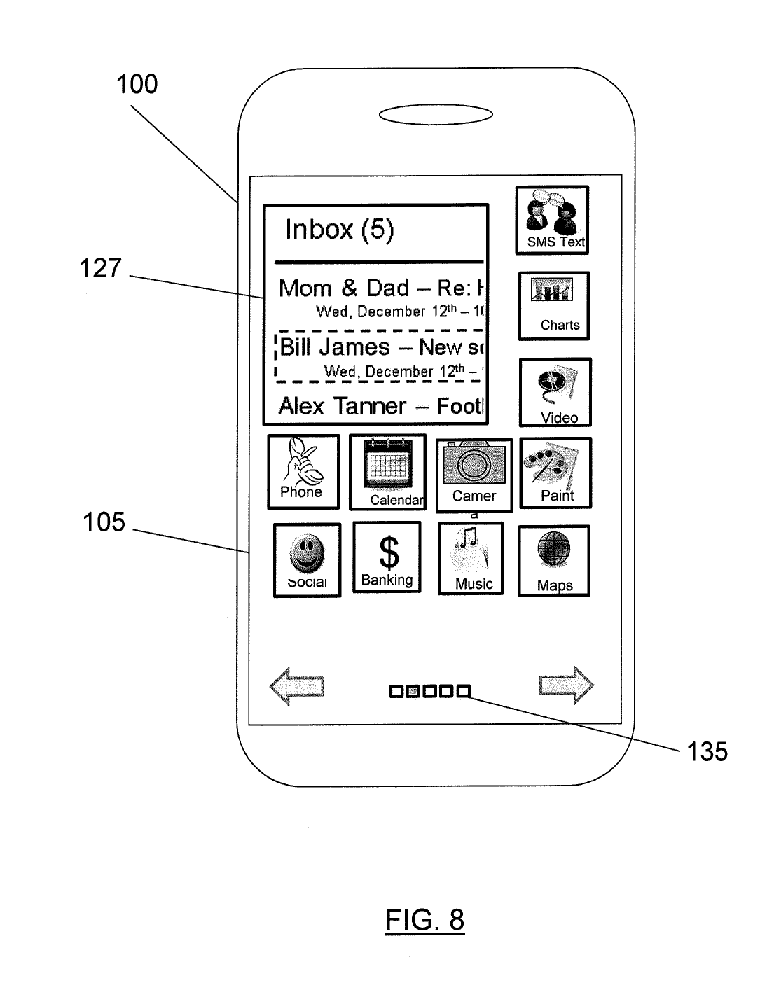

FIG. 8 illustrates the example embodiment of FIGS. 3 and 6; however, the tiles representing other programs (e.g. 160, 120) have been re-sized on the display 105 in response to the email program opening to an enlarged version of the partial view of a representation of the full version of the email program 127. As illustrated and with reference to FIG. 3, the tiles representing each of the other available programs have been scaled-down to accommodate the enlarged view of the representation of the full version of the email program 127. Resizing of the other available programs may maintain the complete list of available programs previously displayed while not obscuring any of the tiles representing available programs.

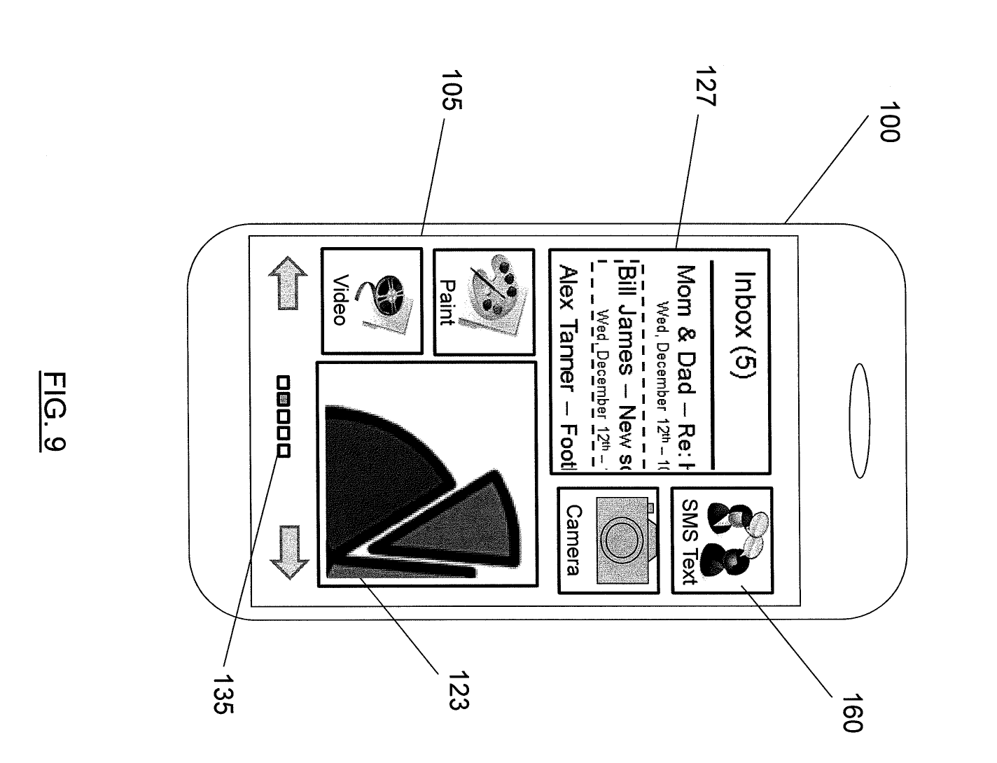

While the illustrated embodiments of FIGS. 6, 7, and 8 depict the enlarged tile 127 depicting a representation of a full version of a program disposed in the upper left corner of the display 105, the position of the enlarged tile 127 may be determined by the original location of the tile representing the program 125 or a preferred location of the display where enlarged tiles 127 may be most accessible (e.g., proximate the middle of the display 105). For example, a tile in the lower right corner of the display may be opened to an intermediate operational interface that is displayed in the lower right corner of the display. FIG. 9 illustrates the example embodiment of FIG. 6 with the tile representing the charts program 120 opened to an enlarged version of a tile depicting a representation of the full version of the chart program 123 presented in the lower right corner of the display 105. Further, as illustrated, an advantage of tiles depicting a representation of a full version of the program that they represent may include that multiple instance of such tiles may be presented on the display 105 simultaneously. As the tiles depicting a representation of a full version of the consume less processing capacity and memory, the processing capabilities of the device 100 may not be significantly affected by multiple instances of such tiles being active as they would by multiple instances of full programs being active.

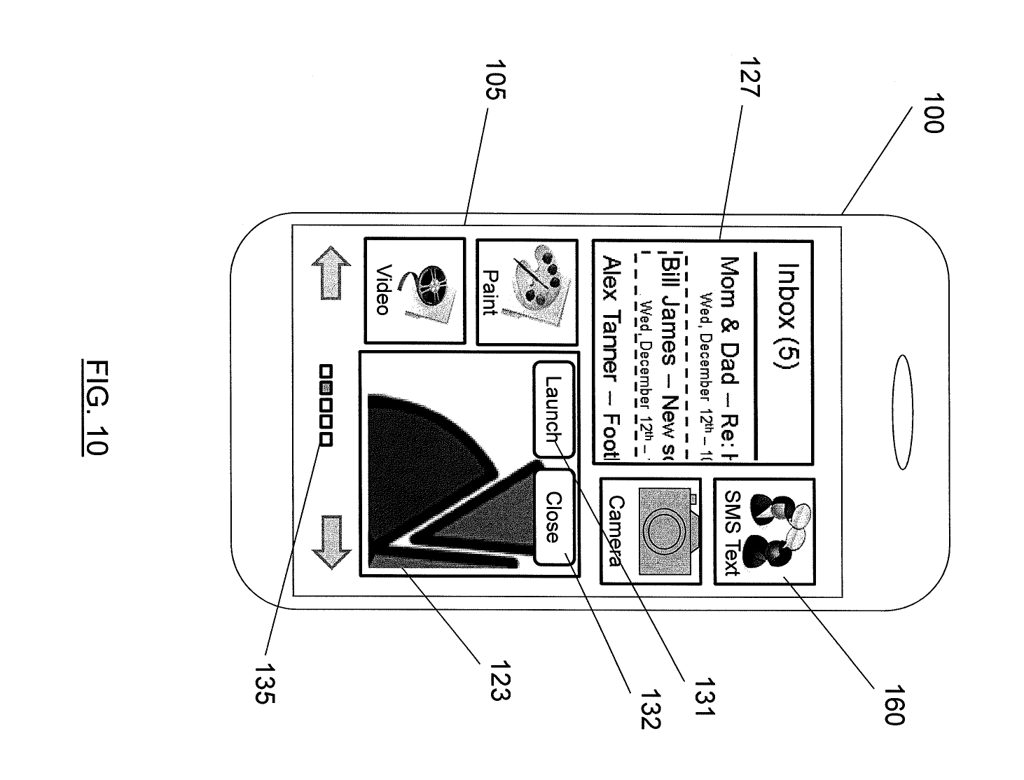

As noted above, tiles depicting representations of full versions of programs may include interactive elements. FIG. 10 illustrates an example embodiment where the enlarged tile depicting a representation of a full version of a chart program 123 includes an interactive element 131 to launch the full version of the program and another interactive element 132 to close the tile depicting the representation of a full version of the chart program 123 to return it to a tile (e.g., an icon).

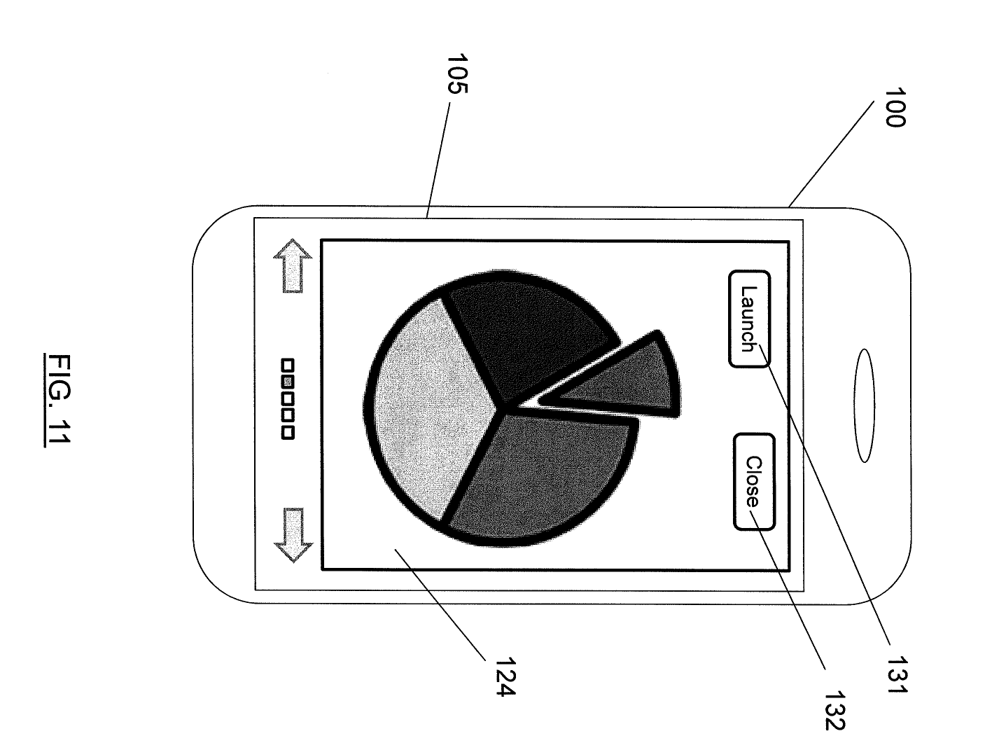

A user may be presented with the enlarged version of the tile depicting a representation of a full version of the program; however, the user may wish to see a greater portion of the representation of the full version of the program. As illustrated in FIG. 11, a user may cause the enlarged version of the tile depicting a representation of the full version of the program to be further enlarged to illustrate the full view of the representation rather than a partial view visible within smaller tiles. In the illustrated embodiment, the further enlarged tile 124 depicts the full view as if a user was viewing the full version of the program; however, the tile 124 merely presents a representation of the full version of the program such that processing capacity is not compromised. Further, the user may launch the program or close the tile using the interface elements 131 and 132 respectively.

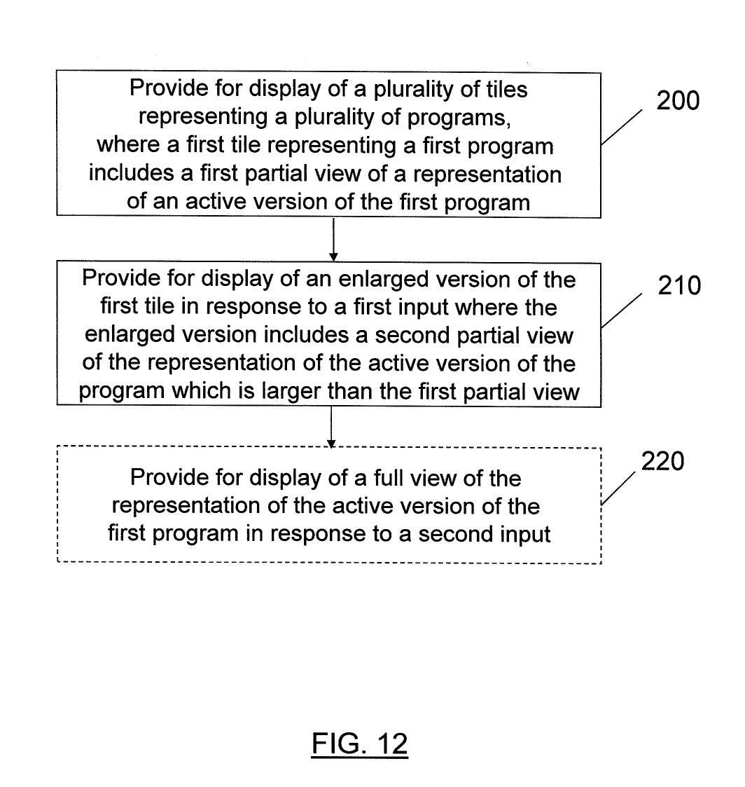

FIG. 12 is a flowchart of a method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user device and executed by a processor in the user device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 12, may include providing for display of a plurality of tiles representing a plurality of programs, where the first tile representing a first program includes a partial view of a representation of a full version of the first program at 200. The method may also include providing for display of an enlarged version of the first tile in response to a first input where the enlarged version includes a second partial view of the representation of the full version of the program which is larger than the first partial view at 210. The method may optionally include (as illustrated by the dashed lines) providing for display of a full view of the representation of the full version of the first program in response to a second input at 220.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein. With reference to the method of FIG. 12, in some example embodiments, the first partial view of the representation of the full version of the first program may depict a portion of the representation of the full version of the first program in the same scale as the full view of the representation of the full version of the first program. The second partial view of the representation of the full version of the first program may depict a portion of the representation of the full version of the first program in the same scale as the full view of the representation of the full version of the first program. All elements of the full view of the representation of the full version of the first program are accessible for viewing in the first partial view and the second partial view of the representation of the full version of the first program via panning. The method may include repositioning at least one of the plurality of tiles representing a plurality of programs in response to the first tile becoming an enlarged version of the first tile. The method may include reducing the size of at least one of the plurality of tiles representing a plurality of programs in response to providing for display of an enlarged version of the first tile. The first program may include a home screen.

In an example embodiment, an apparatus for performing the method of FIG. 12 above may comprise a processor (e.g., the processor 70) configured to perform some or each of the operations (200-220) described above. The processor 70 may, for example, be configured to perform the operations (200-220) by performing hardware implemented logical functions, executing stored instructions, or executing algorithms for performing each of the operations. Alternatively, the apparatus may comprise means for performing each of the operations described above.

An example of an apparatus according to an example embodiment may include at least one processor and at least one memory including computer program code. The at least one memory and the computer program code may be configured to, with the at least one processor, cause the apparatus to perform the operations 200-220 (with or without the modifications and amplifications described above in any combination).

An example of a computer program product according to an example embodiment may include at least one computer-readable storage medium having computer-executable program code portions stored therein. The computer-executable program code portions may include program code instructions for performing operations 200-220 (with or without the modifications and amplifications described above in any combination).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing for display of a plurality of tiles representing a plurality of programs, wherein a first tile of the plurality of tiles representing a first program comprises a first partial view of a representation of a full version of the first program; and
providing for display of an enlarged version of the first tile in response to a first input, wherein the enlarged version comprises a second partial view of the representation of the full version of the first program which is larger than the first partial view.

2. The method of claim 1, wherein the first partial view of the representation of the full version of the first program depicts a portion of the representation of the full version of the first program in the same scale as a full view of the representation of the full version of the first program.

3. The method of claim 2, wherein the second partial view of the representation of the full version of the first program depicts a portion of the representation of the full version of the first program in the same scale as the full view of the representation of the full version of the first program.

4. The method of claim 1, wherein one or more elements of the full view of the representation of the full version of the first program are accessible for viewing in the first partial view and the second partial view of the representation of the full version of the first program via panning.

5. The method of claim 1, further comprising repositioning at least one of the plurality of tiles representing a plurality of programs in response to the first tile becoming an enlarged version of the first tile.

6. The method of claim 1, further comprising reducing the size of at least one of the plurality of tiles representing a plurality of programs in response to providing for display of an enlarged version of the first tile.

7. The method of claim 1, wherein the first program comprises at least one of a home screen, a menu, or an application presenting collection of multiple programs.

8. An apparatus comprising at least one processor and at least one memory including computer program code, the at least one memory and the computer program code configured to, with the at least one processor, cause the apparatus to:
provide for display of a plurality of tiles representing a plurality of programs, wherein a first tile of the plurality of tiles representing a first program comprises a first partial view of a representation of a full version of the first program; and
provide for display of an enlarged version of the first tile in response to a first input, wherein the enlarged version comprises a second partial view of the representation of the full version of the first program which is larger than the first partial view.

9. The apparatus of claim 8, wherein the first partial view of the representation of the full version of the first program depicts a portion of the representation of the full version of the first program in the same scale as the full view of the representation of the full version of the first program.

10. The apparatus of claim 9, wherein the second partial view of the representation of the full version of the first program depicts a portion of the representation of the full version of the first program in the same scale as the full view of the representation of the full version of the first program.

11. The apparatus of claim 8, wherein one or more elements of the full view of the representation of the full version of the first program are accessible for viewing in the first partial view and the second partial view of the representation of the full version of the first program via panning.

12. The apparatus of claim 8, wherein the apparatus is further caused to reposition at least one of the plurality of tiles representing a plurality of programs in response to the first tile becoming an enlarged version of the first tile.

13. The apparatus of claim 8, wherein the apparatus is further caused to reduce the size of at least one of the plurality of tiles representing a plurality of programs in response to providing for display of an enlarged version of the first tile.

14. The apparatus of claim 8, wherein the first program comprises at least one of a home screen, a menu, or an application presenting collection of multiple programs.

15. A computer program product comprising at least one non-transitory computer-readable storage medium having computer executable program code instructions stored therein, the computer executable program code instructions comprising:
program code instructions for providing for display of a plurality of tiles representing a plurality of programs, wherein a first tile of the plurality of tiles representing a first program comprises a first partial view of a representation of a full version of the first program; and
program code instructions for providing for display of an enlarged version of the first tile in response to a first input, wherein the enlarged version comprises a second partial view of the representation of the full version of the first program which is larger than the first partial view.

16. The computer program product of claim 15, wherein the first partial view of the representation of the full version of the first program depicts a portion of the representation of the full version of the first program in the same scale as the full view of the representation of the full version of the first program.

17. The computer program product of claim 16, wherein the second partial view of the representation of the full version of the first program depicts a portion of the representation of the full version of the first program in the same scale as the full view of the representation of the full version of the first program.

18. The computer program product of claim 15, wherein one or more elements of the full view of the representation of the full version of the first program are accessible for viewing in the first partial view and the second partial view of the representation of the full version of the first program via panning.

19. The computer program product of claim 15, further comprising program code instructions for repositioning at least one of the plurality of tiles representing a plurality of programs in response to the first tile becoming an enlarged version of the first tile.

20. The computer program product of claim 15, further comprising program code instructions for reducing the size of at least one of the plurality of tiles representing a plurality of programs in response to providing for display of an enlarged version of the first tile.
